(19) United States
(12) Patent Application Publication
(10) Pub. No.: US 2020/0247088 A1
(43) Pub. Date: Aug. 6, 2020

(54) MULTILAYER SHEET, COATING FIBERS, COATING FIBER BUNDLE, AND FIRE-REINFORCED PLASTIC

(71) Applicant: SEKISUI CHEMICAL CO., LTD., Osaka-city, Osaka (JP)

(72) Inventors: Junnosuke Murakami, Gamagori-city, Aichi (JP); Takahiro Yamaguchi, Gamagori-city, Aichi (JP)

(21) Appl. No.: 16/637,253

(22) PCT Filed: Aug. 9, 2018
(86) PCT No.: PCT/JP2018/029952

§ 371 Date: Feb. 6, 2020

(30) Foreign Application Priority Data
Aug. 9, 2017 (JP) 2017-154433
Dec. 28, 2017 (JP) 2017-254013

(51) Int. Cl. B32B 7/023; B32B 9/04

(52) U.S. Cl. CPC B32B 7/023; D06M 11/83; B32B 9/047

(57) ABSTRACT

Provided is a multilayer sheet which can provide a color and a metallic luster favorably, while leaving design of a surface of a fiber substrate. The multilayer sheet according to the present invention is a multilayer sheet including a fiber substrate and a color tone adjusting layer disposed on a surface of the fiber substrate. The multilayer sheet includes a first surface and a second surface on a side opposite to the first surface. The fiber substrate is disposed on a side the first surface of the multilayer sheet, and the color tone adjusting layer is disposed on a side the second surface of the multilayer sheet. The color tone adjusting layer is a layer having a property that makes a color tone of the second surface of the multilayer sheet different from a color tone of the surface of the fiber substrate. The color tone adjusting layer has optical transparency.

### TECHNICAL FIELD

The present invention relates to a multilayer sheet using a fiber substrate. The present invention further relates to coated fibers and a coated fiber bundle using fibers. The present invention furthermore relates to a fiber-reinforced plastic including the multilayer sheet, the coated fibers, or the coated fiber bundle.

### BACKGROUND ART

In order to enhance the design of the fiber substrate, the fiber substrate may be colored. For example, the fiber substrate may be colored by applying a paint containing a pigment or a dye on the surface of the fiber substrate or by dyeing fibers themselves.

Examples of such a fiber substrate include carbonaceous substrates such as carbon fiber substrates. The surface of the carbonaceous substrate is generally black. In order to enhance the design of the carbonaceous substrate, the carbonaceous substrate may be colored.

A fiber substrate subjected to coloring treatment is disclosed in Patent Document 1 below. Patent Document 1 below discloses carbon fibers (colored fiber substrate) having a lightness L* of 20 or more in an L*a*b* color system measured using a reflection spectrum in a visible region at an incident angle of 60 degrees and a light receiving angle of 45 degrees. In Patent Document 1, a paint containing a pigment or a dye is used for the coloring treatment.

### RELATED ART DOCUMENT

### Patent Document

Patent Document 1: JP 2010-229587 A

### SUMMARY OF THE INVENTION

### Problems to be Solved by the Invention

When a paint containing a pigment or dye is applied to the surface of a fiber substrate such as a carbonaceous substrate, a colored layer is formed on the surface of the fiber substrate. As a result, a surface pattern of the fiber substrate is less likely to be visually recognized at a portion where the surface of the fiber substrate is covered with the colored layer. Moreover, a luster of the fiber substrate may be impaired at the portion where the surface of the fiber substrate is covered with the colored layer. As a result, the unique design of the fiber substrate may be impaired. Moreover, it is difficult to impart a metallic luster to the surface of the fiber substrate only by applying a paint to the surface of the fiber substrate.

Even when fibers themselves are dyed, it is difficult to impart a metallic luster to the fiber substrate.

An object of the present invention is to provide a multilayer sheet which can provide a color and a metallic luster favorably, while leaving design of the surface of a fiber substrate.

One of the objects of the present invention is to provide a multilayer sheet which can provide a color and a metallic luster favorably while leaving the design of the surface of a carbonaceous substrate itself.

A further object of the present invention is to provide coated fibers and a coated fiber bundle which can provide a color and a metallic luster favorably, while leaving the design of the surface of a fiber. A furthermore object of the present invention is to provide a fiber-reinforced plastic including the multilayer sheet, the coated fibers, or the coated fiber bundle.

### Means for Solving the Problems

According to a broad aspect of the present invention, there is provided a multilayer sheet including a fiber substrate and a color tone adjusting layer disposed on a surface of the fiber substrate. The multilayer sheet includes a first surface and a second surface on a side opposite to the first surface. The fiber substrate is disposed on a side the first surface of the multilayer sheet, and the color tone adjusting layer is disposed on a side the second surface of the multilayer sheet. The color tone adjusting layer is a layer having a property that makes a color tone of the second surface of the multilayer sheet different from a color tone of the surface of the fiber substrate. The color tone adjusting layer has optical transparency.

In a specific aspect of the multilayer sheet according to the present invention, the color tone adjusting layer has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3.

According to a broad aspect of the present invention, there is provided a multilayer sheet including a fiber substrate and a color tone adjusting layer disposed on a surface of the fiber substrate. The multilayer sheet includes a first surface and a second surface on a side opposite to the first surface. The fiber substrate is disposed on a side the first surface of the multilayer sheet, and the color tone adjusting layer is disposed on a side the second surface of the multilayer sheet. The color tone adjusting layer has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3. The color tone adjusting layer has optical transparency.

In a specific aspect of the multilayer sheet according to the present invention, the color tone adjusting layer does not contain a pigment, and the color tone adjusting layer does not contain a dye.

In a specific aspect of the multilayer sheet according to the present invention, the fiber substrate is a synthetic fiber substrate.

In a specific aspect of the multilayer sheet according to the present invention, the fiber substrate is a carbon fiber substrate.

In a specific aspect of the multilayer sheet according to the present invention, M in MOₓ and M in MNₓ are each silicon, germanium, gallium, zinc, silver, gold, titanium, aluminum, tin, copper, iron, molybdenum, niobium, or Indium.

In a specific aspect of the multilayer sheet according to the present invention, an average thickness of the color tone adjusting layer is 1 nm or more and 200 nm or less.

In a specific aspect of the multilayer sheet according to the present invention, a visible light transmittance of the color tone adjusting layer is 8% or more.

In a specific aspect of the multilayer sheet according to the present invention, between the second surface of the multilayer sheet and the surface of the fiber substrate, a color difference ΔE*ab in an L*a*b* color system measured in accordance with JIS Z8781-4: 2013 is 10 or more.

In a specific aspect of the multilayer sheet according to the present invention, in the measurement of lightness in the L*a*b* color system in accordance with JIS Z8781-4: 2013, a lightness L* of the second surface of the multilayer sheet is higher by 5 or more than the lightness L* of the surface of the fiber substrate.

In a specific aspect of the multilayer sheet according to the present invention, the multilayer sheet includes the color tone adjusting layer as a first color tone adjusting layer, and further includes a second color tone adjusting layer between the fiber substrate and the first color tone adjusting layer.

In a specific aspect of the multilayer sheet according to the present invention, a metal element or metalloid element contained most in the first color tone adjusting layer is silicon, and a metal element or metalloid element contained most in the second color tone adjusting layer is germanium, gallium, zinc, silver, gold, titanium, aluminum, tin, copper, iron, molybdenum, niobium, or indium.

According to a broad aspect of the present invention, provided are coated fibers including fibers and a color tone adjusting layer disposed on a surface of the fibers, the color tone adjusting layer has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3. The color tone adjusting layer has optical transparency.

According to a broad aspect of the present invention, provided is a coated fiber bundle having a plurality of fibers, in which the plurality of fibers include the coated fiber described above.

According to a broad aspect of the present invention, provided is a fiber-reinforced plastic including the multilayer sheet described above.

According to a broad aspect of the present invention, provided is a fiber-reinforced plastic including the coated fibers described above.

According to a broad aspect of the present invention, provided is a fiber-reinforced plastic including the coated fiber bundle described above.

### Effect of the Invention

The present invention can provide the multilayer sheet which can provide a color and a metallic luster favorably, while leaving the design of the surface of the fiber substrate.

The present invention can provide the multilayer sheet which can provide a color and a metallic luster favorably, while leaving the design of the surface of a carbonaceous substrate.

The present invention can provide the coated fibers which can provide a color and a metallic luster favorably, while leaving the design of the surface of the fibers.

### BRIEF DESCRIPTION OF DRAWING

FIG. 1 is a cross-sectional view showing a multilayer sheet according to a first embodiment of the present invention.

### MODE FOR CARRYING OUT THE INVENTION

Hereinafter, the present invention will be described in detail.

### [Multilayer Sheet]

A multilayer sheet (hereinafter sometimes referred to as a multilayer sheet (1)) according to the present invention includes a fiber substrate and a color tone adjusting layer (sometimes referred to as a first color tone adjusting layer in order to distinguish it from a second color tone adjusting layer described later) disposed on the surface of the fiber substrate. The multilayer sheet (1) according to the present invention has a first surface and a second surface on the side opposite to the first surface. In the multilayer sheet (1) according to the present invention, the fiber substrate is disposed on a side the first surface of the multilayer sheet, and the color tone adjusting layer is disposed on a side the second surface of the multilayer sheet. In the multilayer sheet (1) according to the present invention, the color tone adjusting layer is a layer having a property that makes a color tone of the second surface of the multilayer sheet different from a color tone of the surface of the fiber substrate. In the multilayer sheet (1) according to the present invention, the color tone adjusting layer has optical transparency.

A multilayer sheet (hereinafter sometimes referred to as a multilayer sheet (2)) according to the present invention includes a fiber substrate and a color tone adjusting layer (sometimes referred to as a first color tone adjusting layer in order to distinguish it from a second color tone adjusting layer described later) disposed on the surface of the fiber substrate. The multilayer sheet (2) according to the present invention has a first surface and a second surface on the side opposite to the first surface. In the multilayer sheet (2) according to the present invention, the fiber substrate is disposed on a side the first surface of the multilayer sheet, and the color tone adjusting layer is disposed on a side the second surface of the multilayer sheet. In the multilayer sheet (2) according to the present invention, the color tone adjusting layer has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3. In the multilayer sheet (2) according to the present invention, the color tone adjusting layer has optical transparency.

In the multilayer sheet according to the present invention, the color tone adjusting layer having optical transparency means that the surface of the fiber substrate is visually recognized through the color tone adjusting layer on the second surface of the multilayer sheet. In the present invention, when the color tone adjusting layer has optical transparency, it is preferable that a surface pattern of the fiber substrate be visually recognized through the color tone adjusting layer on the second surface of the multilayer sheet, and it is preferable that a luster of the fiber substrate be visually recognized through the color tone adjusting layer.

Since the multilayer sheet according to the present invention has the above-described configuration, it is possible to provide a color and a metallic luster favorably, while leaving the design of the surface of the fiber substrate.

The fiber substrate may have a luster or may have a surface pattern due to an uneven shape. When a paint containing a pigment or a dye is applied to the surface of the fiber substrate, or when the fiber substrate itself is dyed, it is difficult to provide a color and a metallic luster while leaving the design of the surface of the fiber substrate.

When the fiber substrate is colored by applying a paint containing a pigment or a dye to the surface of the fiber substrate or by dyeing the fibers themselves, if the colored fiber substrate is washed by laundering, etc., the paint may peel off, or color fading may occur.

When the material of the fiber substrate is glass fibers or the like, it is difficult itself to perform coloring treatment using a paint containing a pigment or a dye. Even if the glass fibers or the like are colored, a paint tends to peel off.

When the fiber substrate is colored by applying a paint containing a pigment or a dye to the surface of the fiber substrate or by dyeing fibers themselves, it is difficult to impart the angular dependence of color tone to the colored fiber substrate. When a fiber substrate having a specific fiber structure is used to impart the angular dependence of color tone to the colored fiber substrate, production cost is increased.

When the fiber substrate is a carbonaceous substrate, the carbonaceous substrate may have a luster or may have a surface pattern due to an uneven shape. When a paint containing a pigment or a dye is applied to the surface of a carbonaceous substrate, a surface pattern of the carbonaceous substrate is less likely to be visually recognized at a portion where the surface of the carbonaceous substrate is covered with the paint containing the pigment or the dye. Moreover, the luster of the carbonaceous substrate may be impaired at the portion where the surface of the carbonaceous substrate is covered with the paint containing the pigment or the dye. As a result, the unique design of the carbonaceous substrate may be impaired.

On the other hand, in the multilayer sheet according to the present invention, a color can be provided favorably without impairing the surface pattern and luster of the fiber substrate. Further, in the multilayer sheet according to the present invention, a metallic luster can be imparted to the multilayer sheet.

Further, in the multilayer sheet according to the present invention, even when the multilayer sheet is washed by laundering, etc., the color tone adjusting layer is hardly peeled off.

Further, in the multilayer sheet according to the present invention, the material of the fiber substrate is not specifically limited, and a color and a metallic luster can be provided.

Further, in the multilayer sheet according to the present invention, the angular dependence of color tone can be imparted to the multilayer sheet. Therefore, the color tone can be changed depending on an angle at which the multilayer sheet is viewed.

A mechanism in which a color and a metallic luster are imparted to the multilayer sheet according to the present invention is considered a cause of (1) the effect of the color of the color tone adjusting layer, (2) the effect of light absorption by the color tone adjusting layer, and (3) the effect of optical interference generated by the color tone adjusting layer.

Since the multilayer sheet according to the present invention has the above performance, the multilayer sheet can be suitably used as a decorative fiber sheet.

Hereinafter, specific embodiments of the present invention will be described with reference to the drawings.

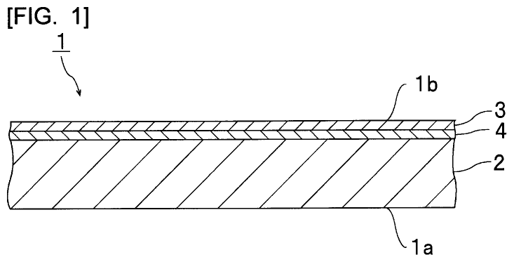

FIG. 1 is a cross-sectional view showing a multilayer sheet according to a first embodiment of the present invention.

A multilayer sheet 1 according to FIG. 1 includes a fiber substrate 2, a first color tone adjusting layer 3, and a second color tone adjusting layer 4. The second color tone adjusting layer 4 is disposed between the fiber substrate 2 and the first color tone adjusting layer 3. The multilayer sheet may include only the first color tone adjusting layer or may not include the second color tone adjusting layer.

The first color tone adjusting layer 3 has optical transparency.

The second color tone adjusting layer 4 preferably has optical transparency. The second color tone adjusting layer having optical transparency means that the surface of the fiber substrate is visually recognized through the second color tone adjusting layer on a second surface of the multilayer sheet. When the second color tone adjusting layer has optical transparency, it is preferable that a surface pattern of the fiber substrate be visually recognized through the second color tone adjusting layer on the second surface of the multilayer sheet, and it is preferable that a luster of the fiber substrate be visually recognized through the second color tone adjusting layer.

The multilayer sheet 1 has a first surface 1a and a second surface 1b on the side opposite to the first surface 1a.

The fiber substrate 2 is disposed on the first surface 1a side of the multilayer sheet 1. The first color tone adjusting layer 3 is disposed on the second surface 1b side of the multilayer sheet 1. The second color tone adjusting layer 4 is disposed on the second surface 1b side of the multilayer sheet 1. The fiber substrate 2, the second color tone adjusting layer 4, and the first color tone adjusting layer 3 are arranged in this order.

The multilayer sheet 1 includes one first color tone adjusting layer 3 and one second color tone adjusting layer 4. Each of the first color tone adjusting layer and the second color tone adjusting layer may be a single layer or a multilayer.

Hereinafter, details of the respective layers constituting a multilayer sheet will be described.

### (Fiber Substrate)

The fiber substrate is disposed on a side the first surface of the multilayer sheet in the multilayer sheet. The fiber substrate may be a single layer or a multilayer.

The material of the fiber substrate is not particularly limited. One kind of the materials of the fiber substrate may be used alone, and two or more kinds thereof may be used in combination.

Examples of the material of the fiber substrate include natural fibers and synthetic fibers. Examples of the fiber substrate include natural fiber substrates and synthetic fiber substrates. In view of excellent durability, the fiber substrate is preferably a synthetic fiber substrate.

The synthetic fiber substrate may be a carbonaceous substrate such as a carbon fiber substrate. Therefore, the fiber substrate is preferably a carbonaceous substrate.

Examples of the natural fiber include cotton fiber, hemp fiber, wool fiber, and silk fiber.

Examples of the synthetic fiber include polyester fiber, nylon fiber, acetate fiber, rayon fiber, cupra fiber, acrylic fiber, vinylon fiber, asbestos fiber, glass fiber, aramid fiber, and carbon fiber.

From the viewpoint of enhancing design of the surface of the fiber substrate, the material of the fiber substrate is preferably glass fiber, aramid fiber, carbon fiber, nylon fiber, or polyester fiber, more preferably carbon fiber. From the viewpoint of enhancing the design of the surface of the fiber substrate, the fiber substrate is preferably a glass fiber substrate, an aramid fiber substrate, a carbon fiber substrate, a nylon fiber substrate, or a polyester fiber substrate, more preferably a carbon fiber substrate.

The fiber substrate may be a fiber substrate in which one type of fiber is woven, or may be a fiber substrate in which a plurality of fibers are woven in a composite manner. Examples of the fiber substrate in which a plurality of fibers are woven in a composite manner include a glass fiber-aramid fiber composite substrate, a carbon fiber-aramid fiber composite substrate, and a glass fiber-carbon fiber composite substrate.

From the viewpoint of enhancing a luster of the multilayer sheet, the material of the fiber substrate is preferably glass fiber. The fiber substrate is preferably a glass fiber substrate. Since the glass fiber is a glossy fiber, luster due to the glossiness of the glass fiber can be imparted to the multilayer sheet.

From the viewpoint of improving adhesion between the fiber substrate and the color tone adjusting layer, the material of the fiber substrate is preferably nylon fiber or polyester fiber. The fiber substrate is preferably a nylon fiber substrate or a polyester fiber substrate. When the adhesion between the fiber substrate and the color tone adjusting layer is high, the color tone adjusting layer is more hardly peeled off even if the multilayer sheet is washed by laundering, etc.

From the viewpoint of suppressing crazes or cracks in the color tone adjusting layer, the material of the fiber substrate is preferably a carbonaceous material such as carbon fiber. The fiber substrate is preferably a carbonaceous substrate such as a carbon fiber substrate, more preferably a carbon fiber substrate. The material of the carbonaceous substrate is a carbonaceous material (for example, carbon fiber), and the carbonaceous material is generally black. One kind of the carbonaceous materials may be used alone, and two or more kinds thereof may be used in combination. Carbon fiber is a fiber having a large elastic modulus. Therefore, when the fiber substrate is a carbon fiber substrate, even if the carbon fiber substrate is pulled, the carbon fiber substrate is less likely to be stretched; therefore, it is possible to favorably suppress crazes and cracks of the color tone adjusting layer disposed on the surface of the carbon fiber substrate.

From the viewpoint of enhancing design of the surface of the carbonaceous substrate, the material of the fiber substrate is preferably carbon fiber. The fiber substrate is preferably a carbon fiber substrate.

The fiber substrate is preferably a fiber sheet. The fiber substrate may be a woven fabric or a knitted fabric. A pattern may be present on the surface of the fiber substrate, or an image may be drawn on the surface of the fiber substrate by dyeing or the like. In the multilayer sheet according to the present invention, even if a pattern is present on the surface of the fiber substrate or an image is drawn, the pattern or image of the fiber substrate can be visually recognized through the color tone adjusting layer.

When the fiber substrate is a carbonaceous substrate, the shape of the carbonaceous substrate may be a flat sheet. The carbonaceous substrate may be a woven fabric or a knitted fabric. When the shape of the carbonaceous substrate is a flat sheet, a pattern may be present on the surface. In the multilayer sheet according to the present invention, even if a pattern is present on the surface of the fiber substrate or an image is drawn, the pattern or image of the fiber substrate can be visually recognized through the color tone adjusting layer.

The fiber substrate is preferably a fiber woven fabric, a fiber knitted fabric, or a fiber nonwoven fabric. As the fiber substrate, only one of fiber woven fabric, fiber knitted fabric, and fiber nonwoven fabric may be used, or two or more of them may be used in combination.

When the fiber substrate is a fiber woven fabric, the weaving method is not particularly limited, but plain weaving or twill weaving is preferable.

The carbon fiber substrate is preferably a carbon fiber woven fabric, a carbon fiber knitted fabric, or a carbon fiber nonwoven fabric. As the carbon fiber substrate, only one of carbon fiber woven fabric, carbon fiber knitted fabric, and carbon fiber nonwoven fabric may be used, or two or more of them may be used in combination.

When the fiber substrate is a carbonaceous substrate, particularly when the carbonaceous substrate is a carbon fiber woven fabric, a carbon fiber knitted fabric, or a carbon fiber nonwoven fabric, unique design of the carbonaceous substrate, such as an uneven shape, a pattern, and a luster can be imparted to the multilayer sheet. Formation of a specific color tone adjusting layer can achieve visual recognition of the unique design even if the color tone adjusting layer is disposed on the surface of the carbonaceous substrate. When the carbonaceous material is carbon fiber, a multilayer sheet that is lightweight and excellent in strength can be obtained. In a preferred embodiment of the present invention, from the viewpoint of remarkably expressing an uneven shape and pattern of the carbonaceous substrate, the carbonaceous substrate is preferably a carbon fiber substrate, more preferably a carbon fiber woven fabric or carbon fiber knitted fabric.

When the carbonaceous substrate is a carbon fiber woven fabric, the weaving method is not particularly limited, but plain weaving or twill weaving is preferable, and twill weaving is more preferable.

The basis weight of the fiber substrate is not particularly limited, but is preferably 1 g/m² or more, more preferably 10 g/m² or more, and preferably 700 g/m² or less, more preferably 500 g/m² or less.

When the fiber is carbon fiber, the basis weight of the carbon fiber is not particularly limited, but is preferably 50 g/m² or more, more preferably 100 g/m² or more, and preferably 700 g/m² or less, more preferably 500 g/m² or less.

The filament diameter of the fiber is not particularly limited, but is preferably 1 μm or more, more preferably 2 μm or more, and preferably 50 μm or less, more preferably 20 μm or less.

When the fiber is carbon fiber, the filament diameter of the carbon fiber is not particularly limited, but is preferably 1 μm or more, more preferably 2 μm or more, and preferably 50 μm or less, more preferably 20 μm or less.

When the fiber is carbon fiber, the density of the carbon fiber is not particularly limited, but is preferably 1/inch or more, more preferably 2/inch or more, preferably 50/inch or less, more preferably 20/inch or less.

In one embodiment of the present invention, from the viewpoint of increasing the strength of the multilayer sheet, the multilayer sheet may be a fiber-reinforced plastic. The fiber-reinforced plastic includes the multilayer sheet. The fiber-reinforced plastic preferably includes the multilayer sheet and plastic. The multilayer sheet may be used as a material of a fiber-reinforced plastic. The fiber substrate may be used as a material of a fiber-reinforced plastic. When the fiber substrate is used as the material of the fiber-reinforced plastic, unique design of the fiber substrate, such as an uneven shape, a pattern, and a luster can be imparted to the fiber-reinforced plastic. Formation of a specific color tone adjusting layer can achieve visual recognition of the unique design after the fiber-reinforced plastic is molded even if the color tone adjusting layer is disposed on the surface of the fiber substrate. Moreover, by using the fiber substrate as the material of the fiber-reinforced plastic, a fiber-reinforced plastic that is lightweight and excellent in strength can be obtained.

Examples of the fiber-reinforced plastic include carbon fiber-reinforced plastic, glass fiber-reinforced plastic, and aramid fiber-reinforced plastic.

In one embodiment of the present invention, from the viewpoint of increasing the strength of the multilayer sheet, the carbonaceous material may be a carbon fiber-reinforced plastic, and the carbonaceous substrate may be a carbon fiber-reinforced plastic substrate. When the carbonaceous substrate is a carbon fiber-reinforced plastic substrate, unique design of a carbon fiber-reinforced plastic substrate, such as an uneven shape, a pattern, and a luster can be imparted to the multilayer sheet. Formation of a specific color tone adjusting layer can achieve visual recognition of the unique design even if the color tone adjusting layer is disposed on the surface of the carbon fiber-reinforced plastic substrate. When the carbonaceous material is carbon fiber-reinforced plastic, a multilayer sheet that is lightweight and excellent in strength can be obtained.

### (Color Tone Adjusting Layer)

The color tone adjusting layer is a layer disposed on the surface of the fiber substrate. The color tone adjusting layer is disposed on a side toward the second surface of the multilayer sheet in the multilayer sheet. The color tone adjusting layer is a layer having a property that makes a color tone of the second surface of the multilayer sheet different from a color tone of the surface of the fiber substrate. The color tone adjusting layer is a layer having optical transparency.

The multilayer sheet may include the color tone adjusting layer as the first color tone adjusting layer, and may further include the second color tone adjusting layer between the fiber substrate and the first color tone adjusting layer.

From the viewpoint of favorably imparting a color to the multilayer sheet, the first color tone adjusting layer preferably has a property that makes the name of the surface color according to JIS Z8102: 2001 of the second surface of the multilayer sheet different from the name of the surface color according to JIS 28102: 2001 of the surface of the fiber substrate.

When the second color tone adjusting layer is provided, a laminate of the first color tone adjusting layer and the second color tone adjusting layer preferably has a property that makes the name of the surface color according to JIS 28102: 2001 of the second surface of the multilayer sheet different from the name of the surface color according to JIS Z8102: 2001 of the surface of the fiber substrate. In this case, a color can be favorably imparted to the multilayer sheet.

In JIS 28102: 2001, 269 colors are defined for the name of the surface color.

From the viewpoint of favorably imparting a color to the multilayer sheet, the first color tone adjusting layer preferably has a property that makes a spectral reflectance curve in visible light of the second surface of the multilayer sheet different from a spectral reflectance curve in visible light of the surface of the fiber substrate.

When the second color tone adjusting layer is provided, the laminate of the first color tone adjusting layer and the second color tone adjusting layer preferably has a property that makes a spectral reflectance curve in visible light of the second surface of the multilayer sheet different from a spectral reflectance curve in visible light of the surface of the fiber substrate. In this case, a color can be favorably imparted to the multilayer sheet.

From the viewpoint of suppressing a decrease in optical transparency (for example, visible light transmittance) of the first color tone adjusting layer, the first color tone adjusting layer preferably does not contain a pigment. From the viewpoint of suppressing a decrease in optical transparency (for example, visible light transmittance) of the first color tone adjusting layer, the first color tone adjusting layer preferably does not contain a dye. When the first color tone adjusting layer not containing a pigment is formed, or when the first color tone adjusting layer not containing a dye is formed, unique design of the fiber substrate such as an uneven shape, a surface pattern, and a luster can be effectively prevented from being impaired on the second surface of the multilayer sheet. Formation of the first color tone adjusting layer not containing both a pigment and a dye can more effectively prevent unique design of the fiber substrate such as an uneven shape, a surface pattern, and a luster from being impaired on the second surface of the multilayer sheet. In addition, formation of the first color tone adjusting layer not containing both a pigment and a dye can improve adhesion between the fiber substrate and the first color tone adjusting layer.

When the first color tone adjusting layer contains a pigment, the content of the pigment in 100% by weight of the first color tone adjusting layer is preferably 0.1% by weight or less, more preferably 0.01% by weight or less. When the first color tone adjusting layer contains a dye, the content of the dye in 100% by weight of the first color tone adjusting layer is preferably 0.1% by weight or less, more preferably 0.01% by weight or less. When the content of the pigment or the dye is equal to or less than the above upper limit, it is possible to more effectively prevent unique design of the fiber substrate such as an uneven shape, a surface pattern, and a luster from being impaired and to improve the adhesion between the fiber substrate and the first color tone adjusting layer.

When the second color tone adjusting layer is provided, from the viewpoint of suppressing a decrease in

optical transparency (for example, visible light transmittance) of the second color tone adjusting layer, the second color tone adjusting layer preferably does not contain a pigment. From the viewpoint of suppressing a decrease in optical transparency (for example, visible light transmittance) of the second color tone adjusting layer, the second color tone adjusting layer preferably does not contain a dye. When the second color tone adjusting layer not containing a pigment is formed, or when the second color tone adjusting layer not containing a dye is formed, unique design of the fiber substrate such as an uneven shape, a surface pattern, and a luster can be effectively prevented from being impaired on the second surface of the multilayer sheet. Formation of the second color tone adjusting layer not containing both a pigment and a dye can more effectively prevent unique design of the fiber substrate such as an uneven shape, a surface pattern, and a luster from being impaired on the second surface of the multilayer sheet. In addition, formation of the second color tone adjusting layer not containing both the pigment and the dye can improve adhesion between the fiber substrate and the second color tone adjusting layer.

When the second color tone adjusting layer contains a pigment, the content of the pigment in 100% by weight of the second color tone adjusting layer is preferably 0.1% by weight or less, more preferably 0.01% by weight or less. When the second color tone adjusting layer contains a dye, the content of the dye in 100% by weight of the second color tone adjusting layer is preferably 0.1% by weight or less, more preferably 0.01% by weight or less. When the content of the pigment or the dye is equal to or less than the above upper limit, it is possible to more effectively prevent unique design of the fiber substrate such as an uneven shape, a surface pattern, and a luster from being impaired and to improve the adhesion between the fiber substrate and the second color tone adjusting layer.

In a color tone adjusting layer containing a pigment and a color tone adjusting layer containing a dye, generally, the optical transparency is low, and the surface of the fiber substrate is hardly visually recognized. In the color tone adjusting layer containing the pigment and the color tone adjusting layer containing the dye, generally, the optical transparency is low, and a surface pattern of the fiber substrate is hardly visually recognized. In the color tone adjusting layer containing the pigment and the color tone adjusting layer containing the dye, generally, a metallic luster is hardly imparted.

The first color tone adjusting layer preferably contains a metal element or a metalloid element. In this case, the first color tone adjusting layer may contain a metal element, may contain a metalloid element, or may contain both the metal element and the metalloid element. One kind of the metal element and the metalloid element may be used alone, and two or more kinds thereof may be used in combination.

From the viewpoint of favorably imparting a color and a metallic luster to the multilayer sheet, the first color tone adjusting layer preferably has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3. In MOₓ and MNₓ, 0 represents oxygen, and N represents nitrogen. x in MOₓ and x in MNₓ may each be 0 or may exceed 0. When x is 0, a layer containing MOₓ represents a layer containing a metal alone or a metalloid alone. When x is 0, a layer containing MNₓ represents a layer containing a metal alone or a metalloid alone. When x exceeds 0, the layer containing MOₓ represents a layer containing a metal oxide or a metalloid oxide. When x exceeds 0, the layer containing MNₓ represents a layer containing a metal nitride or a metalloid nitride. When M in MOₓ is silicon, x preferably represents a number less than 1. When M in MNₓ is silicon, x preferably represents the number of 4/3 or less.

The first color tone adjusting layer may be a layer including both MOₓ and MNₓ. In this case, M in MOₓ and MNₓ may be the same metal or metalloid, or may be different metals or metalloids. Two Ms in MOₓ and MNₓ may be the same metal or metalloid, or may be different metals or metalloids. x in MOₓ and MNₓ may be the same number or different numbers. Two xs in MOₓ and MNₓ may be the same number or different numbers.

The first color tone adjusting layer may be a layer containing MOₓN_{y}. In this case, M represents an n-valent metal or metalloid, and x and y represent numbers satisfying x more than 0, y more than 0, and x+y less than n/2. x and y may be the same number or different numbers. The layer containing MOₓN_{y} represents a layer containing metal oxynitride or metalloid oxynitride.

The first color tone adjusting layer may be a layer containing both MOₓ and MOₓN_{y}, may be a layer containing both MNₓ and MOₓN_{y}, and may be a layer containing all of MOₓ, MNₓ, and MOₓN_{y}. In this case, M in MOₓ, MNₓ, and MOₓN_{y} may be the same metal or metalloid, or may be different metals or metalloids. Three Ms in MOₓ, MNₓ, and MOₓN_{y} may be the same metal or metalloid, or may be different metals or metalloids. x in MOₓ, MNₓ, and MOₓN_{y} may be the same number or different numbers. Three xs in MOₓ, MNₓ, and MOₓN_{y} may be the same number or different numbers.

Regarding the valence of oxygen atoms, for example, a cross section of a layer containing MOₓ or MOₓN_{y} is subjected to elemental analysis by FE-TEM-EDX (for example, “JEM-ARM200F” manufactured by JEOL Ltd.), and x is calculated from an element ratio of M and O per area of the cross section of the layer containing MOₓ or MOₓN_{y}, whereby the valence of oxygen atoms can be calculated.

Regarding the valence of nitrogen atoms, for example, a cross section of a layer containing MNₓ or MOₓN_{y} is subjected to elemental analysis by FE-TEM-EDX (for example, “JEM-ARM200F” manufactured by JEOL Ltd.), and x or y is calculated from an element ratio of M and N per area of the cross section of the layer containing MNₓ or MOₓN_{y}, whereby the valence of nitrogen atoms can be calculated.

From the viewpoint of more preferably imparting a color and a metallic luster to the multilayer sheet, the first color tone adjusting layer preferably contains silicon, germanium, gallium, zinc, silver, gold, titanium, aluminum, tin, copper, iron, molybdenum, niobium, or indium. The first color tone adjusting layer may contain only one kind of these metal elements or metalloid elements, or may contain two or more kinds. From the viewpoint of further favorably imparting a color to the multilayer sheet, the first color tone adjusting layer preferably contains silicon.

From the viewpoint of more favorably imparting a color and a metallic luster to the multilayer sheet, M in MOₓ, M in MNₓ, and M in MOₓN_{y} are each more preferably silicon, germanium, gallium, zinc, silver, gold, titanium, aluminum, tin, copper, iron, molybdenum, niobium, or indium. M in MOₓ, M in MNₓ, and M in MOₓN_{y} may each contain only one kind of these metal elements or metalloid elements, or may contain two or more kinds. From the viewpoint of further favorably imparting a color to the multilayer sheet, M in MOₓ, M in MNₓ, and M in MOₓN_{y} are each preferably silicon.

The second color tone adjusting layer may be present between the first color tone adjusting layer and the fiber substrate.

From the viewpoint of effectively making the color tone of the second surface of the multilayer sheet different from the color tone of the surface of the fiber substrate, a metal element or a metalloid element contained most in the first color tone adjusting layer is preferably different from a metal element or a metalloid element contained most in the second color tone adjusting layer.

From the viewpoint of imparting a specific surface color and metallic luster to the multilayer sheet, the second color tone adjusting layer preferably contains germanium, gallium, zinc, silver, gold, titanium, aluminum, tin, copper, iron, molybdenum, niobium, nickel, chromium, or indium. The second color tone adjusting layer may contain only one kind of these metal elements or metalloid elements, or may contain two or more kinds.

From the viewpoint of more favorably imparting a metallic luster to the multilayer sheet, the metal element or metalloid element contained most in the second color tone adjusting layer is preferably aluminum, silver, or titanium.

From the viewpoint of further favorably imparting a color and a metallic luster to the multilayer sheet, the metal element or metalloid element contained most in the color tone adjusting layer (first color tone adjusting layer) is preferably silicon.

The metal element or metalloid element contained most in the color tone adjusting layer (first color tone adjusting layer) is preferably silicon, and the metal element or metalloid element contained most in the second color tone adjusting layer is preferably germanium, gallium, zinc, silver, gold, titanium, aluminum, tin, copper, iron, molybdenum, niobium, or indium. In this case, a color and a metallic luster can be more favorably imparted to the multilayer sheet.

The visible light transmittance of the first color tone adjusting layer is preferably 5% or more, more preferably 8% or more, and preferably 100% or less, more preferably 90% or less. When the visible light transmittance of the first color tone adjusting layer is the above lower limit or more and the above upper limit or less, the uneven shape and luster of the fiber substrate are hardly impaired, and a color and a metallic luster can be favorably imparted to the multilayer sheet.

The visible light transmittance of the second color tone adjusting layer is preferably 5% or more, more preferably 8% or more, and preferably 100% or less, more preferably 90% or less. When the visible light transmittance of the second color tone adjusting layer is the above lower limit or more and the above upper limit or less, the uneven shape and luster of the fiber substrate are hardly impaired, and a color and a metallic luster can be favorably imparted to the multilayer sheet.

The visible light transmittance is an average value of measured values obtained when a transmittance in a wavelength range of 380 nm to 780 nm is measured at intervals of 5 nm. The visible light transmittance can be measured using, for example, a spectrophotometer (for example, “U-4100” manufactured by Hitachi High-Technologies Corporation). An integrating sphere can be used as a detector.

The visible light transmittance may be measured by producing a first or second color tone adjusting layer having an average thickness equivalent to that of the first or second color tone adjusting layer of the multilayer sheet.

Examples of the respective formation methods of the first color tone adjusting layer and the second color tone adjusting layer include sputtering (reactive sputtering method, RF sputtering method), and vapor deposition methods (plasma vapor deposition method, vacuum vapor deposition method (EB vapor deposition method, ion plating method, IAD method)). From the viewpoint of improving the adhesion between the fiber substrate and the color tone adjusting layer and unlikely making the color tone adjusting layer peeling even if the multilayer sheet is washed or the like, the first color tone adjusting layer and the second color tone adjusting layer are each preferably formed by sputtering and are each preferably a sputtering film.

When the color tone adjusting layer contains MOₓ, MNₓ, or MOₓN_{y}, the x and y can be adjusted according to manufacturing conditions. For example, when the color tone adjusting layer is formed by sputtering, the x and y can be adjusted by appropriately adjusting a partial pressure of oxygen or nitrogen in a chamber.

The average thicknesses of the first color tone adjusting layer and the second color tone adjusting layer are changed, so that the visible light transmittances of the first color tone adjusting layer and the second color tone adjusting layer can be changed, or the color tone of the second surface of the multilayer sheet can be changed to various colors.

The surface of the color tone adjusting layer opposite to the fiber substrate side is preferably not flat. The surface of the color tone adjusting layer opposite to the fiber substrate side preferably has uneven shapes. The multilayer sheet preferably has, on the surface of the color tone adjusting layer opposite to the fiber substrate side, uneven shapes corresponding to uneven shapes of the surface of the fiber substrate on the color tone adjusting layer side. Such uneven shapes of the color tone adjusting layer can be favorably formed by sputtering or the like. On the other hand, when the color tone adjusting layer is formed on the fiber substrate by applying a paint containing a dye or a paint containing a pigment, the surface of the color tone adjusting layer is usually flat.

The average thickness of the first color tone adjusting layer is preferably 1 nm or more, more preferably 5 nm or more, further preferably 7 nm or more, particularly preferably 10 nm or more, most preferably 13 nm or more. The average thickness of the first color tone adjusting layer is preferably 200 nm or less, more preferably 190 nm or less, further preferably 180 nm or less, particularly preferably 170 nm or less, most preferably 150 nm or less. When the average thickness of the first color tone adjusting layer is equal to or more than the above lower limit, a color can be favorably imparted to the multilayer sheet. When the average thickness of the first color tone adjusting layer is the above upper limit or less, design of the fiber substrate such as an uneven shape and a luster is hardly impaired. Further, when the average thickness of the first color tone adjusting layer is the above upper limit or less, the moisture permeability, surface roughness, refraction resistance, moisture content, etc. of the fiber substrate are hardly impaired.

When the second color tone adjusting layer is present between the fiber substrate and the first color tone adjusting layer, the average thickness of the second color tone adjusting layer is preferably 1 nm or more, more preferably 5 nm or more, further preferably 7 nm or more, particularly preferably 10 nm or more, most preferably 13 nm or more. The average thickness of the second color tone adjusting layer is preferably 200 nm or less, more preferably 190 nm or less, further preferably 180 nm or less, particularly preferably 170 nm or less, most preferably 150 nm or less. When the average thickness of the second color tone adjusting layer is equal to or more than the above lower limit, a color can be favorably imparted to the multilayer sheet. When the average thickness of the second color tone adjusting layer is the above upper limit or less, the design of the fiber substrate such as an uneven shape and a luster are hardly impaired. Further, when the average thickness of the second color tone adjusting layer is the above upper limit or less, the surface roughness, refraction resistance, etc. of the fiber substrate are hardly impaired.

The average thickness can be measured, for example, by observing a cross section of each of the first color tone adjusting layer and the second color tone adjusting layer with FE-TEM (for example, “JEM-ARM200F” manufactured by JEOL Ltd.). From a cross-sectional TEM image obtained by FE-TEM, arbitrary 5 points or more separated by a distance of 100 nm or more are selected, and an average value of thicknesses measured at the respective points is defined as the average thickness.

From the viewpoint of favorably imparting a color to the multilayer sheet, between the second surface of the multilayer sheet and the surface of the fiber substrate, a color difference ΔE*ab in an L*a*b* color system measured in accordance with JIS Z8781-4: 2013 is preferably 10 or more, more preferably 15 or more, further preferably 20 or more. The color difference ΔE*ab between the second surface of the multilayer sheet and the surface of the fiber substrate may be 50 or less.

From the viewpoint of favorably imparting a color to the multilayer sheet, in the measurement of a lightness L* in the L*a*b* color system measured in accordance with JIS Z8781-4: 2013, the lightness L* of the second surface of the multilayer sheet is higher than the lightness L* of the surface of the fiber substrate by preferably 5 or more, more preferably 6 or more, further preferably 7 or more. A difference between the lightness L* of the second surface of the multilayer sheet and the lightness L* of the surface of the fiber substrate may be 50 or less.

When the color difference ΔE*ab and the lightness L* of the surface of the fiber substrate are measured, the fiber substrate before disposing the color tone adjusting layer may be used. When the surfaces on both sides of the fiber substrate are the same, the measurement may be performed on the surface of the fiber substrate opposite to the color tone adjusting layer side.

From the viewpoint of favorably imparting a color to the multilayer sheet, the visible light transmittance of the second surface of the multilayer sheet and a visible light reflectance of the surface of the fiber substrate are preferably different by 1% or more, more preferably 2% or more. A difference between the visible light reflectance of the second surface of the multilayer sheet and the visible light reflectance of the surface of the fiber substrate may be 50% or less.

The visible light reflectance can be measured using, for example, a spectrophotometer (for example, “U-4100” manufactured by Hitachi High-Technologies Corporation). An integrating sphere can be used as a detector.

A layer having optical transparency may be stacked on the second surface of the multilayer sheet. The layer having optical transparency is preferably a layer containing, for example, silicon dioxide, titanium dioxide, niobium pentoxide, zinc oxide, aluminum oxide, tin oxide, or indium oxide.

### [Coated Fiber]

The coated fiber according to the present invention includes a fiber and the color tone adjusting layer disposed on the surface of the fiber. In the coated fiber according to the present invention, the color tone adjusting layer has a layer containing MOₓ or MNₓ. In the case of MOₓ, M represents an n-valent metal or metalloid, and x represents the number of 0 or more and less than n/2. In the case of MNₓ, M represents an n-valent metal or metalloid, and x represents the number of 0 or more and less than n/3. In the coated fiber according to the present invention, the color tone adjusting layer has optical transparency.

In the coated fiber according to the present invention, the color tone adjusting layer having optical transparency means that the surface of fibers is visually recognized through the color tone adjusting layer.

The coated fiber is fibrous. The coated fiber does not have a sheet shape.

Examples of the fiber include natural fibers such as cotton fibers, hemp fibers, wool fibers, and silk fibers, and synthetic fibers such as polyester fibers, nylon fibers, acetate fibers, rayon fibers, cupra fibers, acrylic fibers, vinylon fibers, asbestos fibers, glass fibers, aramid fibers, and carbon fibers.

The fiber in the coated fiber is preferably the fiber described in the item [Multilayer Sheet] in the present specification.

The color tone adjusting layer in the coated fiber is preferably the color tone adjusting layer described in the item [Multilayer Sheet] in the present specification.

The coated fiber may include the color tone adjusting layer as the first color tone adjusting layer, and may further include the second color tone adjusting layer between the fibers and the first color tone adjusting layer.

The second color tone adjusting layer in the coated fiber is preferably the second color tone adjusting layer described in the item [Multilayer Sheet] in the present specification.

The first color tone adjusting layer is preferably a layer (metalloid layer) containing a metalloid element. The second color tone adjusting layer is preferably a layer (metal layer) containing a metal element.

The coated fiber preferably has a layer containing a metal oxide (metal oxide layer) on the surface opposite to the fiber side of the color tone adjusting layer (first color tone adjusting layer). The metal oxide layer is preferably the outermost layer of the coated fiber.

In 100% of the surface area of the fibers, the surface area of a portion covered with the color tone adjusting layer (first color tone adjusting layer, a metalloid layer) is preferably 30% or more, more preferably 50% or more, further preferably 70% or more, and preferably 100% or less.

In 100% of the surface area of the fibers, the surface area of a portion covered with the second color tone adjusting layer (metal layer) is preferably 30% or more, more preferably 50% or more, further preferably 70% or more, and preferably 100% or less.

The method of forming each of the first color tone adjusting layer and the second color tone adjusting layer on the surface of the fibers is preferably the formation method described in the item [Multilayer sheet] of the present specification.

In one embodiment of the present invention, from the viewpoint of increasing the strength of the coated fiber, the coated fiber may be a fiber-reinforced plastic. The fiber-reinforced plastic includes the coated fiber. The fiber-reinforced plastic preferably includes the coated fiber and plastic. The coated fiber may be used as a material of the fiber-reinforced plastic. The fibers may be used as a material of the fiber-reinforced plastic. When the fibers are used as the material of the fiber-reinforced plastic, unique design of the fiber substrate, such as an uneven shape, a pattern, and a luster can be imparted to the fiber-reinforced plastic. Formation of a specific color tone adjusting layer can achieve visual recognition of the unique design after the fiber-reinforced plastic is molded even if the color tone adjusting layer is disposed on the surface of the fibers. Moreover, by using the fibers as the material of the fiber-reinforced plastic, a fiber-reinforced plastic that is lightweight and excellent in strength can be obtained.

### [Coated Fiber Bundle]

The coated fiber bundle according to the present invention has a plurality of fibers, and the plurality of fibers include coated fiber described above.

The coated fiber bundle is not particularly limited as long as it has a plurality of fibers. The coated fiber bundle may have fibers other than the coated fiber. In the coated fiber bundle, at least one of the plurality of fibers is the coated fiber.

The number of fibers constituting the coated fiber bundle is preferably 5 or more, more preferably 10 or more, further preferably 20 or more, particularly preferably 50 or more, most preferably 1000 or more. The number of fibers constituting the coated fiber bundle is preferably 50000 or less, more preferably 20000 or less, further preferably 5000 or less, particularly preferably 2000 or less.

The number of the coated fibers constituting the coated fiber bundle is preferably 5 or more, more preferably 10 or more, further preferably 20 or more, particularly preferably 50 or more, most preferably 1000 or more. The number of coated fibers constituting the coated fiber bundle is preferably 50000 or less, more preferably 20000 or less, further preferably 5000 or less, particularly preferably 2000 or less.

Examples of fibers other than the above-described coated fiber include glass fibers (for example, glass wool and glass fibers), mineral fibers (for example, chrysotile, serpentine asbestos, crocidolite asbestos, amosite asbestos, anthophyllite asbestos, tremolite asbestos, and actinolite asbestos), artificial mineral fibers (for example, rock wool and ceramic fibers), inorganic fibers such as metal fibers (for example, stainless steel fibers, aluminum fibers, iron fibers, nickel fibers, and copper fibers); and organic fibers such as synthetic fibers (for example, nylon fibers, polyester fibers, acrylic fibers, vinylon fibers, polyolefin fibers, polyethylene fibers, polypropylene fibers, polyurethane fibers, and aramid fibers), recycled fibers (for example, rayon, polynosic, cupra, lyocell, and acetate), vegetable fibers (for example, cotton fibers, hemp fibers, flax fibers, rayon fibers, polynosic fibers, cupra fibers, lyocell fibers, and acetate fibers), and animal fibers (for example, wool, silk, fishing gut, mohair, cashmere, camel, llama, alpaca, vicuna, angora and spider silk).

In one embodiment of the present invention, from the viewpoint of increasing the strength of the coated fiber bundle, the coated fiber bundle may be made into a fiber-reinforced plastic. The fiber-reinforced plastic includes the coated fiber bundle. The fiber-reinforced plastic preferably includes the coated fiber bundle and plastic. The coated fiber bundle may be used as a material of the fiber-reinforced plastic. The fibers may be used as a material of the fiber-reinforced plastic. When the fibers are used as the material of the fiber-reinforced plastic, unique design of the fiber substrate, such as an uneven shape, a pattern, and a luster can be imparted to the fiber-reinforced plastic. Formation of a specific color tone adjusting layer can achieve visual recognition of the unique design after the fiber-reinforced plastic is molded even if the color tone adjusting layer is disposed on the surface of the fibers. Moreover, by using the fibers as the material of the fiber-reinforced plastic, a fiber-reinforced plastic that is lightweight and excellent in strength can be obtained.

The coated fibers according to the present invention or the coated fiber bundle according to the present invention may be a material of the multilayer sheet according to the present invention. The multilayer sheet according to the present invention can be obtained by forming the coated fiber according to the present invention or the coated fiber bundle according to the present invention into a sheet shape. Since the coated fiber according to the present invention and the coated fiber bundle according to the present invention have a luster while having a vivid color, they are suitably used as the material of the multilayer sheet according to the present invention.

### [Composite Material]

The composite material according to the present invention includes (1) the above-described multilayer sheet and resin, (2) the above-described coated fiber and resin, or (3) the above-described coated fiber bundle and resin.

The resin is not particularly limited, and a conventionally known resin can be used. Examples of the resin include polyamide-based resin (for example, nylon), polyphenylene ether, polyoxymethylene, polybutylene terephthalate, polycarbonate, polymethyl methacrylate (PMMA), polystyrene, polypropylene, polyetherimide, polyethersulfone, and polyvinyl chloride. One kind of the resins may be used alone, and two or more kinds thereof may be used in combination.

The content of the resin in 100% by weight of the composite material is preferably 3% by weight or more, more preferably 5% by weight or more, further preferably 8% by weight or more, and preferably 99% by weight or less, more preferably 90% by weight or less, further preferably 50% by mass or less.

The composite material preferably contains a carbon fiber-reinforced plastic.

The composite material can be produced according to a conventional method.

The composite material can be suitably used as a material of automobiles, aircraft, sports-related products, medical instruments, building members, electrical equipment, and the like. Examples of the sports-related products include golf shafts, tennis rackets, badminton rackets, fishing rods, skis, snowboards, bats, archery, bicycles, boats, canoes, yachts and windsurfing. Examples of the electrical equipment include a housing of a personal computer or the like and a speaker cone.

In one aspect of the present invention, a use as an automotive interior/exterior material is also provided.

The present invention will be described below in more detail by way of Examples and Comparative Examples. The present invention is not limited to the following Examples.

### Example 1

As the fiber substrate, a polyester fiber substrate (“Hikaru Genji TM-3001 E21” manufactured by Masuda Co., Ltd.), which was a woven fabric in which black polyester (30 denier) was woven in a plain weave, was used. The fiber substrate was placed in a vacuum apparatus and evacuated to 8.0×10⁻⁴ Pa or less. Subsequently, argon gas was introduced, and a DC magnetron sputtering method was used to form a SiO_{0.5} layer (average thickness of 15 nm) as the color tone adjusting layer (first color tone adjusting layer) on the surface of the fiber substrate, thus obtaining a multilayer sheet.

### Example 2

Formation of Second Color Tone Adjusting Layer:

A fiber substrate (polyester fiber substrate) in Example 1 was prepared. The fiber substrate was placed in a vacuum apparatus and evacuated to 8.0×10⁻⁴ Pa or less. Subsequently, argon gas was introduced, and a DC magnetron sputtering method was used to form a Ti layer (average thickness of 30 nm) as the second color tone adjusting layer on the surface of the fiber substrate, thus obtaining a laminate of the fiber substrate and the second color tone adjusting layer.

Formation of Color Tone Adjusting Layer (First Color Tone Adjusting Layer):

A laminate of the fiber substrate and the second color tone adjusting layer was placed in a vacuum apparatus and evacuated to 8.0×10⁻⁴ Pa or less. Subsequently, argon gas was introduced, and a DC magnetron sputtering method was used to form a SiO_{0.5} layer (average thickness of 35 nm) as the first color tone adjusting layer on a surface opposite to the fiber substrate of the second color tone adjusting layer, thus obtaining a multilayer sheet.

### Example 3

A multilayer sheet was obtained in the same manner as in Example 2 except that the average thickness of the first color tone adjusting layer (SiO_{0.5} layer) was changed as shown in Table 1.

### Example 4

A multilayer sheet was obtained in the same manner as in Example 2 except that the average thickness of the first color tone adjusting layer (SiO_{0.5} layer) and the second color tone adjusting layer was changed as shown in Table 1, and an Ag layer was formed as the second color tone adjusting layer.

### Example 5

A multilayer sheet was obtained in the same manner as in Example 1 except that a TiO_{0.1} layer was formed as the color tone adjusting layer (first color tone adjusting layer) and the average thickness of the color tone adjusting layer was changed as shown in Table 1.

### Comparative Example 1

The polyester fiber substrate in Example 1 (“Hikaru Genji TM-3001 E21” manufactured by Masuda Co., Ltd.) was used as an evaluation target of Comparative Example 1. In Comparative Example 1, neither the first color tone adjusting layer nor the second color tone adjusting layer was formed.

### Comparative Example 2

A fiber substrate (polyester fiber substrate) in Example 1 was prepared. A paint containing a blue pigment was applied to one side of the fiber substrate to form a colored layer (color tone adjusting layer having no optical transparency, average thickness of 15 μm), thus obtaining a multilayer sheet in which the colored layer was disposed on a side toward the second surface. The visible light transmittance of the colored layer of Comparative Example 2 (color tone adjusting layer having no optical transparency) was less than 1%. The colored layer did not have optical transparency.

### Example 6

As a carbonaceous substrate, a carbon fiber substrate (“TR3523 M” manufactured by Mitsubishi Chemical Corporation, thickness of 0.21 mm) which was a fabric in which carbon fibers (basis weight of 200 g/m², filament diameter of 7 μm, density of 12.5 fibers/inch) were woven in a twill weave was used. The carbonaceous substrate was placed in a vacuum apparatus and evacuated to 5.0×10⁻⁴ Pa or less. Subsequently, argon gas was introduced, and a DC magnetron sputtering method was used to form a SiO_{0.5} layer (average thickness of 15 nm) as the first color tone adjusting layer on the surface of the carbonaceous substrate, thus obtaining a multilayer sheet.

### Example 7

Formation of Second Color Tone Adjusting Layer:

A carbonaceous substrate in Example 6 was prepared. The carbonaceous substrate was placed in a vacuum apparatus and evacuated to 5.0×10⁻⁴ Pa or less. Subsequently, argon gas was introduced, and a DC magnetron sputtering method was used to form a Ti layer (average thickness of 30 nm) as the second color tone adjusting layer on the surface of the carbonaceous substrate, thus obtaining a laminate of the carbonaceous substrate and the second color tone adjusting layer.

Formation of Color Tone Adjusting Layer (First Color Tone Adjusting Layer):

A laminate of the carbonaceous substrate and the second color tone adjusting layer was placed in a vacuum apparatus and evacuated to 5.0×10⁻⁴ Pa or less. Subsequently, argon gas was introduced, and a DC magnetron sputtering method was used to form a SiO_{0.5} layer (average thickness of 35 nm) as the first color tone adjusting layer on a surface opposite to the carbonaceous substrate of the second color tone adjusting layer, thus obtaining a multilayer sheet.

### Examples 8 to 13

A multilayer sheet was obtained in the same manner as in Example 7 except that the thickness of the first color tone adjusting layer (SiO_{0.5} layer) was changed as shown in Table 2 or 3.

### Example 14

A carbonaceous substrate in Example 6 was prepared. On the surface of the substrate, a TiO_{0.1} layer (average thickness of 30 nm) was formed as the first color tone adjusting layer in the same manner as in Example 6 to obtain a multilayer sheet. In Example 14, the second color tone adjusting layer was not formed.

### Comparative Example 3

The carbonaceous substrate in Example 6 (“TR3523 M” manufactured by Mitsubishi Chemical Corporation, thickness of 0.21 mm) was used as an evaluation target of Comparative Example 3. In Comparative Example 3, neither the first color tone adjusting layer nor the second color tone adjusting layer was formed.

### Comparative Example 4

A carbonaceous substrate in Example 6 was prepared. A paint containing a blue pigment was applied to one side of the carbonaceous substrate to form a colored layer (color tone adjusting layer having no optical transparency, average thickness of 15 μm), thus obtaining a multilayer sheet in which the colored layer was disposed on a side toward the second surface. The visible light transmittance of the colored layer of Comparative Example 4 (color tone adjusting layer having no optical transparency) was less than 1%. The colored layer did not have optical transparency.

### Comparative Example 5

A carbonaceous substrate in Example 6 was prepared. A paint containing a red dye (Pigment Red 254) was applied to one side of the carbonaceous substrate to form a colored layer (color tone adjusting layer having no optical transparency, average thickness of 10 μm), thus obtaining a multilayer sheet in which the colored layer was disposed on a side toward the second surface. The visible light transmittance of the colored layer of Comparative Example 5 (color tone adjusting layer having no optical transparency) was less than 1%. The colored layer did not have optical transparency.

### (Evaluation)

### (1) Color Difference

L*, a*, and b* in the L*a*b* color system of the second surface of the multilayer sheet (Examples 1 to 14 and Comparative Examples 2, 4, and 5) and the surface of the fiber substrate (Comparative Examples 1 and 3) were determined in accordance with JIS Z8781-4: 2013, using a spectrophotometer (“U-4100” manufactured by Hitachi High-Technologies Corporation).

The surface of the fiber substrate of Comparative Example 1 corresponds to the surface of the fiber substrate (first surface of the multilayer sheet) in the multilayer sheets (Examples 1 to 5 and Comparative Example 2). The surface of the fiber substrate of Comparative Example 3 corresponds to the surface of the fiber substrate (first surface of the multilayer sheet) in the multilayer sheets (Examples 6 to 14 and Comparative Examples 4 and 5).

The color difference ΔE*ab in the L*a*b* color system between the second surface of the multilayer sheet and the surface of the fiber substrate of the multilayer sheet was obtained from L*, a*, and b* in accordance with JIS Z8781-4: 2013.

### (2) Difference in L*

In the measurement (1) above, the lightness L* was evaluated. A difference between the lightness L* of the second surface of the multilayer sheet and the lightness L* of the surface of the fiber substrate of the multilayer sheet was determined in accordance with JIS Z8781-4: 2013.

### (3) Difference in Visible Light Reflectance

In Examples 1 to 14 and Comparative Examples 2, 4, and 5, the difference between the visible light reflectance of the second surface of the multilayer sheet and the visible light reflectance of the surface of the fiber substrate was determined.

The visible light reflectance was measured at intervals of 5 nm of the reflectance in a wavelength range of 380 nm to 780 nm while the second surface of the multilayer sheet was firmly adhered parallel to an opening of an integrating sphere so that all reflected light rays were received by the integrating sphere. The average value in the measurement range was defined as the visible light reflectance, and a difference between the visible light reflectance of the second surface of the multilayer sheet and the visible light reflectance of the surface of the fiber substrate of the multilayer sheet was determined.

### (4) Color (JIS Classification)

The color of the second surface of the multilayer sheet (Examples 1 to 14 and Comparative Examples 2, 4, and 5) and the color of the surface of the fiber substrate (Comparative Examples 1 and 3) were confirmed visually. The colors were classified in accordance with JIS Z8102: 2001.

### (5) Uneven Shape and Surface Pattern

In Examples 1 to 5 and Comparative Example 2, when the second surface of the multilayer sheet was observed, whether the uneven shape of polyester fibers used for the fiber substrate was not impaired and whether the surface pattern was visually recognized were confirmed visually. In Examples 6 to 14 and Comparative Examples 4 and 5, when the second surface of the multilayer sheet was observed, whether the uneven shape of carbon fibers used for the carbonaceous substrate was not impaired and whether the surface pattern was visually recognized were confirmed visually.

### [Assessment Criteria for Uneven Shape]

∘: Uneven shape is not impaired

x: Uneven shape is impaired

### [Assessment Criteria for Surface Pattern]

∘: Surface pattern is visually recognized

x: Surface pattern is not visually recognized

### (6) Metallic Luster

When the second surface of the multilayer sheet (Examples 1 to 14 and Comparative Examples 2, 4, and 5) and the surface of the fiber substrate (Comparative Examples 1 and 3) were observed, whether the surfaces have a metallic luster was confirmed visually.

The surface of the fiber substrate of Comparative Example 1 corresponds to the surface of the fiber substrate (first surface of the multilayer sheet) in the multilayer sheets (Examples 1 to 5 and Comparative Example 2). The surface of the fiber substrate of Comparative Example 3 corresponds to the surface of the fiber substrate (first surface of the multilayer sheet) in the multilayer sheets (Examples 6 to 14 and Comparative Examples 4 and 5).

### [Assessment Criteria for Metallic Luster]

∘∘: The surface has a great metallic luster.

∘: The surface has a metallic luster.

Δ: The surface has a slight metallic luster.

x: The surface does not have a metallic luster.

### (7) Luster

When the second surface of the multilayer sheet (Examples 1 to 14 and Comparative Examples 2, 4, and 5) and the surface of the fiber substrate (Comparative Examples 1 and 3) were observed, whether a luster of polyester fibers or carbon fibers used for the fiber substrate was not impaired was confirmed visually.

### [Assessment Criteria for Luster]

∘: The surface has a luster.

x: The surface does not have a luster.

### (8) Visible Light Transmittance

The visible light transmittances of the first color tone adjusting layer (Examples 1 to 14) and the colored layer (Comparative Examples 2, 4, and 5) were determined using a spectrophotometer (“U-4100” manufactured by Hitachi High-Technologies Corporation).

The visible light transmittance was measured at intervals of 5 nm of the transmittance in the wavelength range of 380 nm to 780 nm while the first color tone adjusting layer and the colored layer were firmly adhered parallel to an opening of an integrating sphere so that all transmitted light rays were received by the integrating sphere. The average value in the measurement range was defined as the visible light transmittance.

Evaluation was performed using a layer formed on a PET film (“Lumirror U34, thickness of 50 μm” manufactured by Toray Industries, Inc.) as the first color tone adjusting layer or the colored layer.

### (9) Adhesion

An adhesive tape (“Sekisui Sellotape No252” manufactured by Sekisui Chemical Co., Ltd.) with a width of 15 mm and a length of 30 mm was applied to the second surface of the multilayer sheet (Examples 1 to 14 and Comparative Examples 2, 4, and 5), and a 2 kg pressure roller was reciprocated and stuck together. Then, the adhesive tape was peeled off. It was confirmed whether or not the first color tone adjusting layer or the second color tone adjusting layer was attached onto the peeled adhesive tape.

### [Assessment Criteria for Adhesion]

∘: The first color tone adjusting layer or the second color tone adjusting layer is not attached to the adhesive tape.

x: The first color tone adjusting layer or the second color tone adjusting layer is attached to the adhesive tape.

The configurations and results of the multilayer sheets are shown in Tables 1 to 3 below.

TABLE 1

| | | | Example | Example | Example | Example | Example | Comparative | Comparative |
|---|---|---|---|---|---|---|---|---|---|
| | | | 1 | 2 | 3 | 4 | 5 | Example 1 | Example 2 |
| Multilayer | First color tone | Contained main metal | Si | Si | Si | Si | Ti | — | (Blue paint) |
| sheet | adjusting layer | element | | | | | | | |
| | | Average thickness (nm) | 15 | 35 | 115 | 20 | 30 | — | 15 μm |
| | Second color tone | Contained main metal | — | Ti | Ti | Ag | — | — | — |
| | adjusting layer | element | | | | | | | |
| | | Average thickness (nm) | — | 30 | 30 | 50 | — | — | — |
| | Total of average thickness of first color | | 15 | 65 | 145 | 70 | 30 | — | 15 μm |
| | tone adjusting layer and average thickness | | | | | | | | |
| | of second color tone adjusting layer (nm) | | | | | | | | |
| | Material of fiber substrate | | Polyester | Polyester | Polyester | Polyester | Polyester | Polyester | Polyester |
| | | | fiber | fiber | fiber | fiber | fiber | fiber | fiber |
| Evaluation | Second surface of | L* | 51.3 | 39.2 | 55.2 | 20.5 | 56.2 | — | 23.5 |
| | multilayer sheet | a* | 0.75 | −0.6 | 5.2 | 38.5 | 0.5 | — | −6.55 |
| | | b* | 6.33 | −16.2 | 0.1 | 24.2 | 4.9 | — | −32.3 |
| | Surface of fiber | L* | 0.22 | 0.22 | 0.22 | 0.22 | 0.22 | 0.22 | 0.22 |
| | substrate | a* | 1.5 | 1.5 | 1.5 | 1.5 | 1.5 | 1.5 | 1.5 |
| | | b* | −1.03 | −1.03 | −1.03 | −1.03 | −1.03 | −1.03 | −1.03 |
| | Color difference ΔE* ab | | 51.6 | 41.9 | 55.1 | 49.2 | 56.3 | — | 39.8 |
| | Second surface of | Visible light | 18.9 | 9.8 | 16.5 | 25.8 | 12.6 | — | 11.8 |
| | multilayer sheet | reflectance (%) | | | | | | | |
| | Surface of fiber | Visible light | 3.8 | 3.8 | 3.8 | 3.8 | 3.8 | 3.8 | 3.8 |
| | substrate | reflectance (%) | | | | | | | |
| | Difference in visible light reflectance (%) | | 15.1 | 6.0 | 12.7 | 22.0 | 8.8 | — | 8.0 |
| | Difference in lightness L* | | 51.1 | 39.0 | 55.0 | 20.3 | 56.0 | — | 23.28 |
| | Color (JIS classification) | | Muted | Navy | Orange | Purple | Silver | Black | Blue |
| | | | greenish | | | | | | |
| | | | yellow | | | | | | |

| | | | | | | | |
|---|---|---|---|---|---|---|---|
| Uneven shape | ◯ | ◯ | ◯ | ◯ | ◯ | ◯ | × |
| Surface pattern | ◯ | ◯ | ◯ | ◯ | ◯ | ◯ | × |
| Metallic luster | Δ | ◯ | ◯ | ◯◯ | ◯◯ | × | × |
| Luster | ◯ | ◯ | ◯ | ◯ | ◯ | ◯ | × |
| Visible light transmittance of first color | 39.9 | 19.5 | 10.2 | 36.1 | 8.7 | — | 0.8 |
| tone adjusting layer (%) | | | | | | | |
| Adhesion | ◯ | ◯ | ◯ | ◯ | ◯ | — | × |

TABLE 2

| | | | Example | Example | Example | Example | Example | Example |
|---|---|---|---|---|---|---|---|---|
| | | | 6 | 7 | 8 | 9 | 10 | 11 |
| Multilayer | First color tone | Contained main metal | Si | Si | Si | Si | Si | Si |
| sheet | adjusting layer | element | | | | | | |
| | | Average thickness (nm) | 15 | 35 | 40 | 50 | 80 | 115 |
| | Second color tone | Contained main metal | — | Ti | Ti | Ti | Ti | Ti |
| | adjusting layer | element | | | | | | |
| | | Average thickness (nm) | — | 30 | 30 | 30 | 30 | 30 |
| | Total of average thickness of first color tone | | 15 | 65 | 70 | 80 | 110 | 145 |
| | adjusting layer and average thickness of second | | | | | | | |
| | color tone adjusting layer (nm) | | | | | | | |
| | Material of fiber substrate | | Carbon | Carbon | Carbon | Carbon | Carbon | Carbon |
| | | | fiber | fiber | fiber | fiber | fiber | fiber |
| Evaluation | Second surface of | L* | 55.79 | 39.9 | 43.5 | 48.8 | 59.5 | 56.2 |
| | multilayer sheet | a* | 0.81 | −0.5 | −3.8 | −5.7 | −1.7 | 5.3 |
| | | b* | 6.53 | −15.8 | −15.2 | −13.0 | 2.2 | −0.3 |
| | Surface of fiber | L* | 32.8 | 32.8 | 32.8 | 32.8 | 32.8 | 32.8 |
| | substrate | a* | 1 | 1 | 1 | 1 | 1 | 1 |
| | | b* | 4.4 | 4.4 | 4.4 | 4.4 | 4.4 | 4.4 |
| | Color difference ΔE* ab | | 23.1 | 21.5 | 22.8 | 24.6 | 26.9 | 24.3 |
| | Second surface of | Visible light | 25.5 | 10.5 | 11.7 | 13.0 | 20.8 | 21.0 |
| | multilayer sheet | reflectance (%) | | | | | | |
| | Surface of fiber | Visible light | 8.4 | 8.4 | 8.4 | 8.4 | 8.4 | 8.4 |
| | substrate | reflectance (%) | | | | | | |
| | Difference in visible light reflectance (%) | | 17.0 | 2.0 | 3.2 | 4.6 | 12.4 | 12.6 |
| | Difference in lightness L* | | 23.0 | 7.1 | 10.7 | 16.0 | 26.7 | 23.4 |
| | Color (JIS classification) | | Muted | Navy | Blue | Light blue | Yellow | Orange |
| | | | greenish | | | | | |
| | | | yellow | | | | | |

| | | | | | | |
|---|---|---|---|---|---|---|
| Uneven shape | ◯ | ◯ | ◯ | ◯ | ◯ | ◯ |
| Surface pattern | ◯ | ◯ | ◯ | ◯ | ◯ | ◯ |
| Metallic luster | ◯ | ◯◯ | ◯◯ | ◯◯ | ◯◯ | ◯◯ |
| Luster | ◯ | ◯ | ◯ | ◯ | ◯ | ◯ |
| Visible light transmittance of first color tone | 38.8 | 18.7 | 17.6 | 17.7 | 20.3 | 9.6 |
| adjusting layer (%) | | | | | | |
| Adhesion | ◯ | ◯ | ◯ | ◯ | ◯ | ◯ |

TABLE 3

| | | | | | | Comparative | Comparative | Comparative |
|---|---|---|---|---|---|---|---|---|
| | | | Example 12 | Example 13 | Example 14 | Example 3 | Example 4 | Example 5 |
| Multilayer | First color tone | Contained main metal | Si | Si | Ti | — | (Blue | (Red dye) |
| sheet | adjusting layer | element | | | | | pigment) | |
| | | Average thickness (nm) | 125 | 145 | 30 | — | 15 μm | 10 μm |
| | Second color tone | Contained main metal | Ti | Ti | — | — | — | — |
| | adjusting layer | element | | | | | | |
| | | Average thickness (nm) | 30 | 30 | — | — | — | — |
| | Total of average thickness of first color tone | | 155 | 175 | 30 | — | 15 μm | 10 μm |
| | adjusting layer and average thickness of second | | | | | | | |
| | color tone adjusting layer (nm) | | | | | | | |
| | Material of fiber substrate | | Carbon | Carbon | Carbon | Carbon fiber | Carbon fiber | Carbon fiber |
| | | | fiber | fiber | fiber | | | |
| Evaluation | Second surface of | L* | 54.9 | 53.8 | 57.2 | — | 25.44 | 49.1 |
| | multilayer sheet | a* | 4.3 | −2.5 | 0.3 | — | −6.14 | 34.3 |
| | | b* | −3.4 | −4.7 | 5.5 | — | −34.19 | 11.6 |
| | Surface of fiber | L* | 32.8 | 32.8 | 32.8 | 32.8 | 32.8 | 32.8 |
| | substrate | a* | 1 | 1 | 1 | 1 | 1 | 1 |
| | | b* | 4.4 | 4.4 | 4.4 | 4.4 | 4.4 | 4.4 |
| | Color difference AE* ab | | 23.7 | 23.2 | 24.4 | — | 39.9 | 37.8 |
| | Second surface of | Visible light | 20.9 | 20.0 | 15.8 | — | 12.5 | 9.8 |
| | multilayer sheet | reflectance (%) | | | | | | |
| | Surface of fiber | Visible light | 8.4 | 8.4 | 8.4 | 8.4 | 8.4 | 8.4 |
| | substrate | reflectance (%) | | | | | | |

| | | | | | | |
|---|---|---|---|---|---|---|
| Difference in visible light reflectance (%) | 12.5 | 11.6 | 7.4 | — | 4.0 | 1.4 |
| Difference in lightness L* | 22.1 | 21.0 | 24.4 | — | −7.36 | 16.3 |
| Color (JIS classification) | Pink | Blue-gray | Silver | Black | Blue | Pink |
| Uneven shape | ◯ | ◯ | ◯ | — | ◯ | ◯ |
| Surface pattern | ◯ | ◯ | ◯ | × | × | × |
| Metallic luster | ◯◯ | ◯◯ | ◯◯ | ◯ | × | × |
| Luster | ◯ | ◯ | ◯ | ◯ | × | × |
| Visible light transmittance of first color tone | | | | | | |
| adjusting layer (%) | 8.9 | 9.2 | 9.1 | — | 0.8 | 0.7 |
| Adhesion | ◯ | ◯ | ◯ | — | × | × |

### EXPLANATION OF SYMBOLS

1: Multilayer sheet
1a: First surface
1b: Second surface
2: Fiber substrate
3: First color tone adjusting layer
4: Second color tone adjusting layer

1. A multilayer sheet comprising:
a fiber substrate; and
a color tone adjusting layer disposed on a surface of the fiber substrate,
the multilayer sheet comprising a first surface and a second surface on a side opposite to the first surface,
the fiber substrate being disposed on a side the first surface of the multilayer sheet, the color tone adjusting layer being disposed on a side the second surface of the multilayer sheet,
the color tone adjusting layer being a layer having a property that makes a color tone of the second surface of the multilayer sheet different from a color tone of the surface of the fiber substrate,
the color tone adjusting layer having optical transparency.

2. The multilayer sheet according to claim 1, wherein
the color tone adjusting layer includes a layer containing MOₓ or MNₓ,
in the case of MOₓ, M represents an n-valent metal or metalloid, x represents the number of 0 or more and less than n/2, and
in the case of MNₓ, M represents an n-valent metal or metalloid, and x represents the number of 0 or more and less than n/3.

3. A multilayer sheet comprising:
a fiber substrate; and
a color tone adjusting layer disposed on a surface of the fiber substrate,
the multilayer sheet comprising a first surface and a second surface on a side opposite to the first surface,
the fiber substrate being disposed on a side the first surface of the multilayer sheet, the color tone adjusting layer being disposed on a side the second surface of the multilayer sheet,
the color tone adjusting layer comprising a layer containing MOₓ or MNₓ,
in the case of MOₓ, M representing an n-valent metal or metalloid, x representing the number of 0 or more and less than n/2,
in the case of MNₓ, M representing an n-valent metal or metalloid, x representing the number of 0 or more and less than n/3,
the color tone adjusting layer having optical transparency.

4. The multilayer sheet according to claim 1, wherein the color tone adjusting layer does not contain a pigment, and the color tone adjusting layer does not contain a dye.

5. The multilayer sheet according to claim 1, wherein the fiber substrate is a synthetic fiber substrate.

6. The multilayer sheet according to claim 1, wherein the fiber substrate is a carbon fiber substrate.

7. The multilayer sheet according to claim 2, wherein M in MOₓ and M in MNₓ are each silicon, germanium, gallium, zinc, silver, gold, titanium, aluminum, tin, copper, iron, molybdenum, niobium, or Indium.

8. The multilayer sheet according to claim 1, wherein an average thickness of the color tone adjusting layer is 1 nm or more and 200 nm or less.

9. The multilayer sheet according to claim 1, wherein a visible light transmittance of the color tone adjusting layer is 8% or more.

10. The multilayer sheet according to claim 1, wherein between the second surface of the multilayer sheet and the surface of the fiber substrate, a color difference ΔE*ab in an L*a*b* color system measured in accordance with JIS Z8781-4: 2013 is 10 or more.

11. The multilayer sheet according to claim 1, wherein in the measurement of a lightness in the L*a*b* color system in accordance with JIS Z8781-4: 2013, a lightness L* of the second surface of the multilayer sheet is higher by 5 or more than the lightness L* of the surface of the fiber substrate.

12. The multilayer sheet according to claim 1, further comprising the color tone adjusting layer as a first color tone adjusting layer, and furthermore comprising a second color tone adjusting layer between the fiber substrate and the first color tone adjusting layer.

13. The multilayer sheet according to claim 12, wherein a metal element or metalloid element contained most in the first color tone adjusting layer is silicon, and a metal element or metalloid element contained most in the second color tone adjusting layer is germanium, gallium, zinc, silver, gold, titanium, aluminum, tin, copper, iron, molybdenum, niobium, or indium.

14. A coated fiber comprising:
a fiber; and
a color tone adjusting layer disposed on a surface of the fiber,
the color tone adjusting layer including a layer containing MOₓ or MNₓ,
in the case of MOₓ, M representing an n-valent metal or metalloid, x representing the number of 0 or more and less than n/2,
in the case of MNₓ, M representing an n-valent metal or metalloid, x representing the number of 0 or more and less than n/3,
the color tone adjusting layer having optical transparency.

15. A coated fiber bundle comprising a plurality of fibers, the plurality of fibers including the coated fiber according to claim 14.

16. A fiber-reinforced plastic comprising the multilayer sheet according to claim 1.

17. A fiber-reinforced plastic comprising the coated fiber according to claim 14.

18. A fiber-reinforced plastic comprising the coated fiber bundle according to claim 15.
